(19) United States
(12) Patent Application Publication
(10) Pub. No.: US 2015/0367875 A1
(43) Pub. Date: Dec. 24, 2015

(54) HEATER ELEMENT AND STEERING WHEEL

(71) Applicants: TOYODA GOSEI CO., LTD., Kiyosu-shi (JP); KURABE INDUSTRIAL CO., LTD., Hamamatsu-shi (JP)

(72) Inventors: Yoshinori NONOYAMA, Kiyosu-shi (JP); Norio UMEMURA, Kiyosu-shi (JP); Masatsugu SAITO, Hamamatsu-shi (JP); Hironori KATSUMATA, Hamamatsu-shi (JP)

(21) Appl. No.: 14/739,106

(22) Filed: Jun. 15, 2015

(30) Foreign Application Priority Data
Jun. 20, 2014 (JP) 2014-127427

(51) Int. Cl. B62D 1/06

(52) U.S. Cl. CPC B62D 1/065

(57) ABSTRACT

A heater element is disclosed, including a pair of substrates formed from foamed polyurethane resin and a cord-shaped heater disposed between the substrates, and the substrates are bonded together by hot pressing with an adhesive disposed between the substrates such that the cord-shaped heater is fixed between the substrates. The thickness of the heater element after being subjected to hot pressing exceeds 1.00 mm and the weight per unit area of the heater element after being subjected to hot pressing except a weight of the adhesive at an unallocated region where the cord-shaped heater is not disposed is within a range of 0.016 to 0.040 g/cm².

### CROSS REFERENCE TO RELATED APPLICATIONS

The Present application claims priority from Japanese Patent Application No. 2014-127427 of Nonoyama et al., filed on Jun. 20, 2014, the disclosure of which is hereby incorporated into the present application by reference.

### BACKGROUND OF THE INVENTION

1. Field of the Invention

The present invention relates to a flexible sheet-shaped heater element for heating a predetermined region in which a cord-shaped heater is fixed in a sandwiched fashion between a pair of substrates formed of foamed resin sheets. The invention also relates to a steering wheel having such a heater element on the rim for holding for steering.

2. Description of Related Art

JP2011-121477 A discloses a heater element for heating a steering wheel. The heater element is formed by arranging a cord-shaped heater on a sheet-shaped substrate of foamed polyurethane resin, applying foamed chloroprene rubber over there and applying heat and pressure (i.e., by hot pressing) by a heated platen to fix the cord-shaped heater on the substrate.

JP2006-513092 A, which is published also as US2004-169028 A, discloses a method of manufacturing a heater element in which a predetermined sheet-shaped cushion and a separater are hot laminated with a cord-shaped heater sandwiched therebetween.

Conventional heater elements are often mounted on a region of a steering wheel between a base cladding of a rim section of the steering wheel and a leather layer. Since the rim section has a generally oval sectional shape, the outer contour in sectional shape of the base cladding is also formed into generally an oval, and the heater element is arranged in a bent fashion around the base cladding. This configuration tends to cause such an unevenness that the leather layer is partially raised on the outer surface of the rim section due to the presence of the cord-shaped heater. Therefore, it has been demanded to improve the appearance of the rim section.

In order to prevent the shape of the cord-shaped heater from appearing on the outer surface of the rim section, it is conceivable to increase the thickness of a member of the heater element covering the cord-shaped hater. However, this configuration often brings about wrinkles on the outer surface of the leather layer in a vicinity of spokes of the steering wheel, which will also degrade the appearance of the steering wheel. Therefore, it has been demanded to improve the appearance of the rim section in such an instance where a heater element is mounted on a rim section of a steering wheel in a bent fashion.

### SUMMARY OF THE INVENTION

It is an object of the present invention to provide a heater element that does not affect, in an adverse fashion, an appearance of a mounting area of a product on which the heater element is mounted, such as a rim section of a steering wheel, even if the heater element is mounted thereon in a bent fashion. Another object of the invention is to provide a steering wheel that is capable of maintaining a good appearance although equipped with a heater element.

The heater element according to the invention is formed into a sheet shape with flexibility, and includes a pair of substrates formed from foamed polyurethane resin and a cord-shaped heater arranged in a predetermined pattern between the substrates. The substrates are bonded together by hot pressing with an adhesive disposed between the substrates such that the cord-shaped heater is fixed between the substrates. The heater element after being subjected to hot pressing includes an unallocated region where the cord-shaped heater is not disposed. The thickness of the heater element after being subjected to hot pressing exceeds 1.00 mm and a weight per unit area at the unallocated region except a weight of the adhesive is within a range of 0.016 to 0.040 g/cm².

That is, in a hot-pressed state in which the cord-shaped heater is fixed between the substrates, the heater element of the invention has a thickness exceeding 1.00 mm, and the weight per unit area of the heater element except the weight of the adhesive at the unallocated region, where the cord-shaped heater is not disposed but only the substrates are disposed, is within a range of 0.016 to 0.040 g/cm². This configuration will provide an adequate cushioning property to the substrates around the cord-shaped heater, and due to this cushioning property, a protrusive shape, i.e., a heater prominence, caused by the presence of the cord-shaped heater will be prevented from appearing on an outer surface of a leather section even if the heater element is disposed at an inner side of the leather section (i.e., around a base cladding) in a bent fashion at a rim section of a steering wheel, provided that the wire diameter of the cord-shaped heater is normal.

The adhesive used to bond the substrates together is a pressure-sensitive adhesive of acrylic polymer or the like in order not to hinder the retractility of the heater element (or substrates). The adhesive is generally applied to one of the substrates by around 0.1 mm thickness, such that the weight of the adhesive per unit area is 0.01 g/cm².

It will be understood that the weight of the adhesive may vary depending on the kind and amount of adhesive, and that the weight per unit area at the unallocated region of the heater element including both the substrates and adhesive may vary accordingly.

As described above, the heater element of the invention will not affect, in an adverse fashion, an appearance of a product on which the heater element is mounted, such as a rim section of a steering wheel, even if the heater element is mounted thereon in a bent fashion. In the heater element of the invention, moreover, the cord-shaped heater is fixed between the substrates in a sandwiched fashion by hot pressing with the aid of the adhesive. This configuration will facilitate the manufacturing of the heater element since the fixing of the cord-shaped heater to the substrates are conducted easily with no need of sewing or the like. It will be understood that the heater element will be heated when energized without affecting the appearance of an outer surface of the product on which it is mounted.

The heater element of the invention desirably has a less than 4.00 mm thickness after being subjected to hot pressing. The thickness no less than 4.00 mm after hot pressing is too thick and will affect the flexibility of the heater element and degrade the sunken-part follow-up capability, as will be described in detail later. By way of example, if a heater element with no less than 4.00 mm thickness is mounted on an area from a rim section to a spoke adjoining the rim section of a steering wheel, the heater element will have difficulty in following a sunken part of a base cladding mounted around a rim core in shape, but fill up the sunken part and be raised there, thus degrading the appearance of the area.

It is further desired that the weight per unit volume of the heater element after being subjected to hot pressing at the unallocated region except the weight of the adhesive is less than 0.32 g/cm³. If the weight per unit volume of only the substrates after hot pressing is no less than 0.32 g/cm³, the heater element will lose elasticity and wrinkle easily. By way of example, if a heater element with no less than 0.32 g/cm³ weight per unit volume of the substrates only is mounted on an area from a rim section to a spoke adjoining the rim section of a steering wheel, the heater element will wrinkle at the border between the rim section and spoke on an inner circumference of the rim section, which will wrinkle the leather section as well.

If the thickness of the heater element after being subjected to hot pressing is 2.00 mm, the heater element will exert an adequate sunken-part follow-up performance and elasticity.

If such a heater element is mounted on a steering wheel including a rim section for holding for steering, the rim section including a rim core and a cladding member that covers the ring core and the cladding member including a base cladding disposed adjacent the rim core and a leather section disposed on an outer surface of the steering wheel, such that the heater element is disposed between the base cladding and the leather section, the steering wheel will have a good appearance with no prominence caused by the presence of the cord-shaped heater, although equipped with the heater element.

In the heater element of the invention, it is desired that, out of the two substrates, the substrate for mounting adjacent the leather section has a greater thickness than the substrate for mounting adjacent the base cladding.

This configuration will increase the cushioning property at a side of the leather section and help prevent a prominence on a surface of the leather section caused by the cord-shaped heater from being recognized not only in vision but also in touch.

### BRIEF DESCRIPTION OF DRAWINGS

FIG. 1 is a plan view of a steering wheel on which a heater element embodying the invention is mounted;

FIG. 2 is a cross-sectional view of a rim section of the steering wheel taken along line II-II of FIG. 1;

FIG. 3 is a partially broken plan view of a heater unit using the heater element of the embodiment;

FIG. 4 is a schematic view illustrating a cord-shaped heater used in the heater element of FIG. 3;

FIG. 5 is a schematic view illustrating a cross-sectional structure of the rim section at which the heater element is disposed;

FIG. 6 is a schematic sectional view of the heater element;

FIG. 7 is a schematic view of a hot-press heater manufacturing device used for hot pressing and manufacturing the heater element;

FIG. 8 is a schematic perspective view showing the way the cord-shaped heater of FIG. 4 is arranged in a predetermined pattern on the heater element;

FIG. 9 depicts some problems which can occur in mounting a heater element on a product;

FIG. 10 depicts another problem which can occur in mounting a heater element on a product; and

FIG. 11 is a table showing a result of a test which examined problems of a variety of heater elements manufactured with substrates with different thicknesses and with different hot-pressing condition, when they are mounted on a steering wheel.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

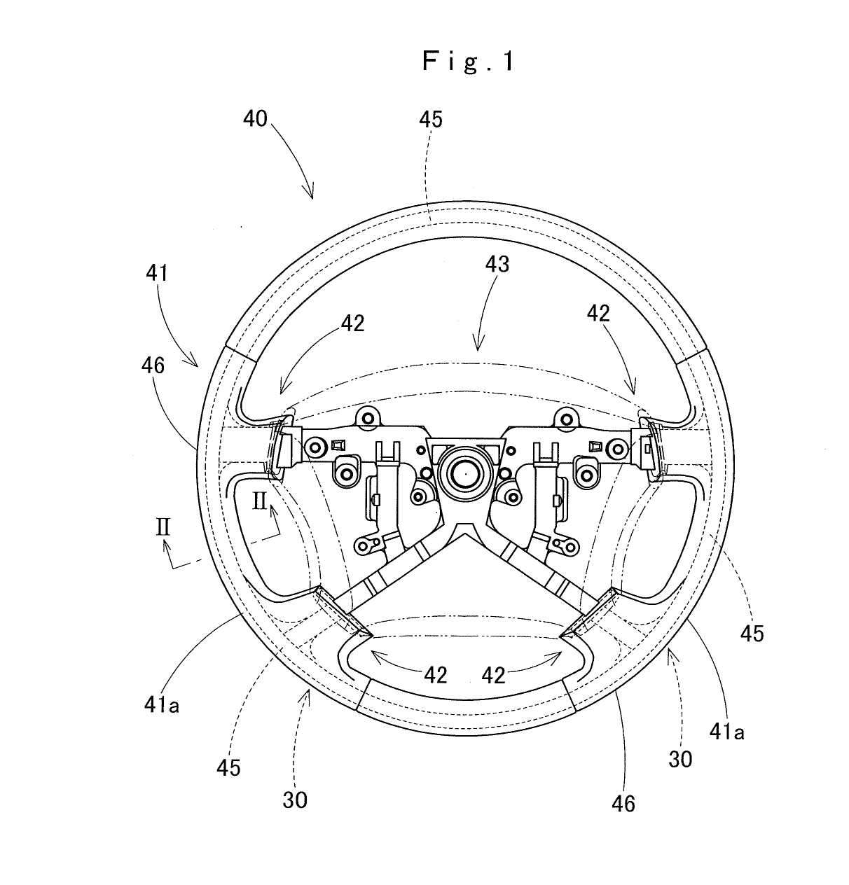

A heater element 20 embodying the invention has such a configuration that a cord-shaped heater 1 is sandwiched between a pair of substrates 10 (first substrate 10A and second substrate 10B) of foamed polyurethane resin, as shown in FIGS. 3 and 6. Opposite ends of the cord-shaped heater 1 are connected to predetermined lead wires 31, and the lead wires 31 are connected to a temperature control device 32 such as a thermistor. Thus the heater element 20 is mounted on a steering wheel 40 for a vehicle shown in FIG. 1 as a heater unit 30. As described later, the heater element 20 is mounted on two mounting areas 41a, which are located on the left side and right side, of a generally annular rim section 41 of the steering wheel 40 for holding for steering.

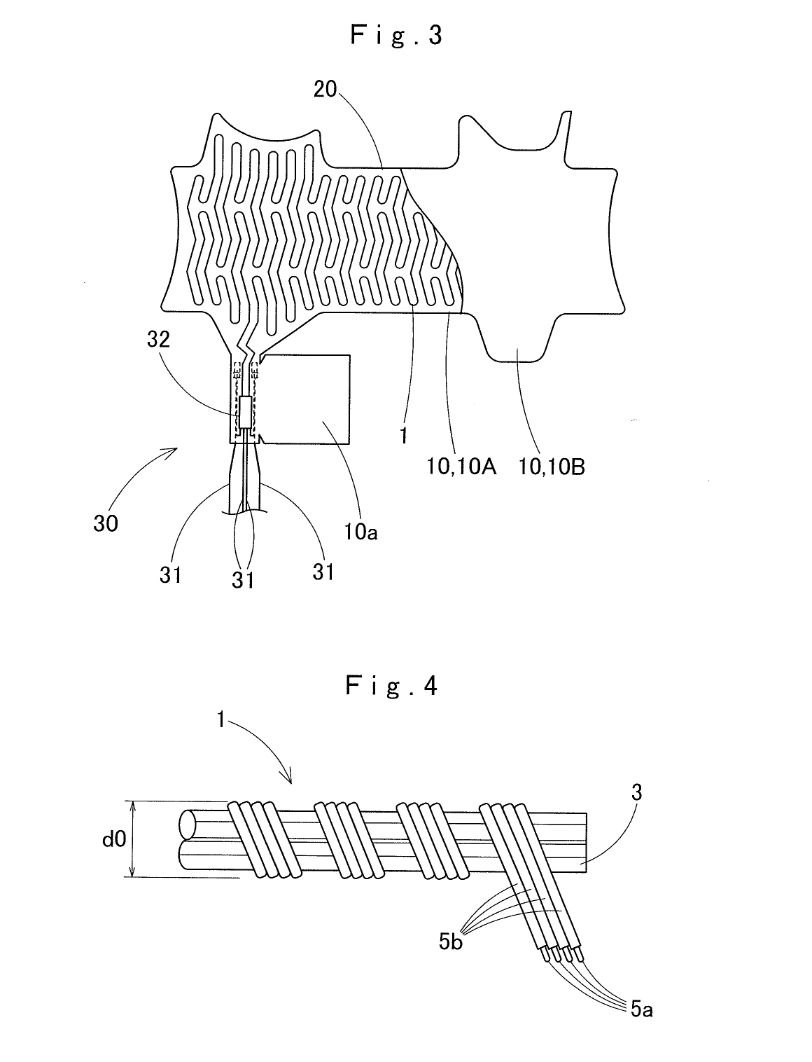

As shown in FIG. 4, a cord-shaped heater 1 for use in the heater element 20 includes a heater core 3 which is composed of bundles of aromatic polyamide fiber and has an outer diameter of about 0.2 mm, and seven conductor wires 5a lined up together and wrapped around the heater core 3 in a helical fashion at 1.00 mm intervals. Each of the conductor wires 5a is composed of an alloy wire of tin and copper and has a diameter of 0.08 mm, and is covered with an insulation covering 5b of polyurethane with an about 0.005 mm thickness. A wire diameter d0 of the cord-shaped heater 1 is 0.37 mm.

Each of the substrates 10 (10A and 10B), which hold the cord-shaped heater 1 in a sandwiching fashion, is a sheet-shaped member formed from foamed polyurethane resin with an apparent density of 0.04 g/cm³ (JIS K 7222) and a hardness of 11.77 (JIS K6400-2).

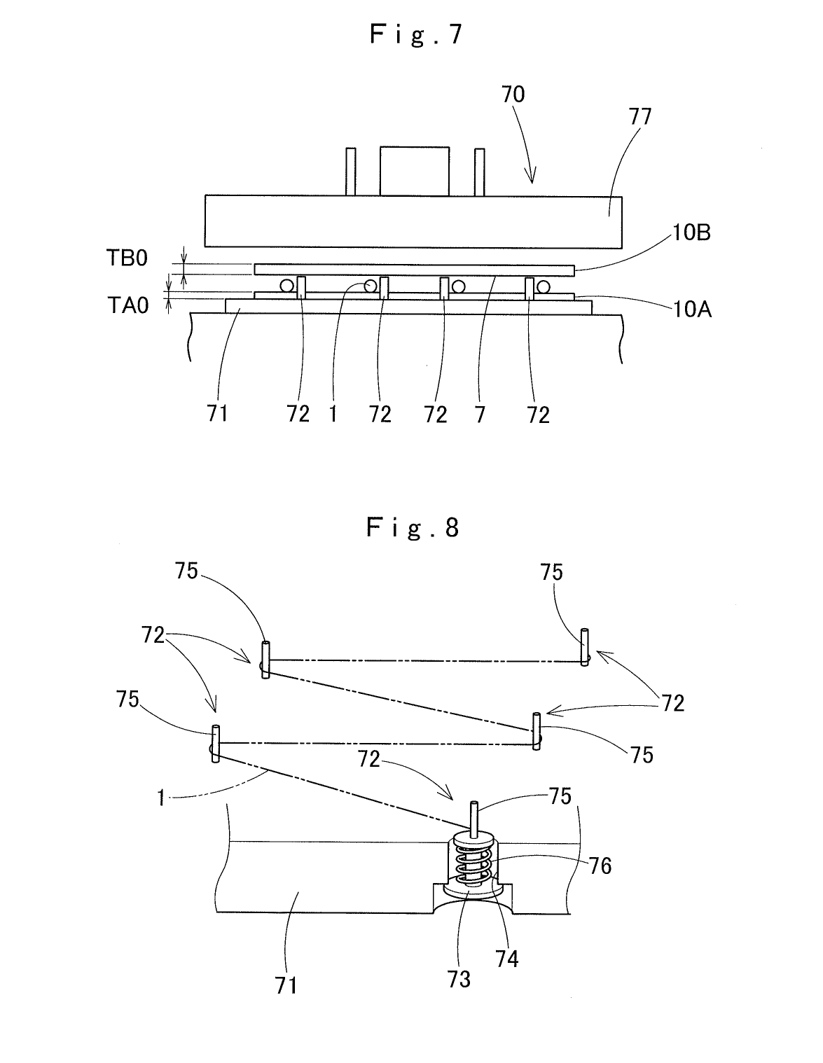

In the illustrated embodiment, the thickness TA0 (FIG. 7) of the substrate 10A before being subjected to hot pressing is 2.0 mm while the thickness TB0 of the substrate 10B before hot pressing is 4.0 mm. The thickness TA1 (FIG. 6) of the substrate 10A after being subjected to hot pressing is 0.5 mm while the thickness TB1 of the substrate 10B after hot pressing is 1.5 mm. The thickness tH0 of the heater element 20 after hot pressing is 2.0 mm.

The cord-shaped heater 1 is arranged in a predetermined pattern between the substrates 10A and 10B. A hot-press heater manufacturing device 70 shown in FIG. 7 is used to arrange the cord-shaped heater 1 in a predetermined pattern between the substrates 10A and 10B and fixing the heater 1 between the substrates 10A and 10B. The heater manufacturing device 70 includes a bottom platen 71 with a plurality of hook mechanisms 72.

As shown in FIG. 8, each of the hook mechanisms 72 includes a pin section 73 which is inserted into a hole 74 bored in the bottom platen 71 from below. The pin section 73 is provided, at the top, with a hook member 75 which is formed into a nail. The hook member 75 is movable in the axial direction and is constantly biased upwardly by a coil spring 76. As indicated by double-dotted lines in FIG. 8, the cord-shaped heater 1 is wound around the hook members 75 of the hook mechanisms 72 one after another, thus is arranged in a predetermined pattern on the first substrate 10A.

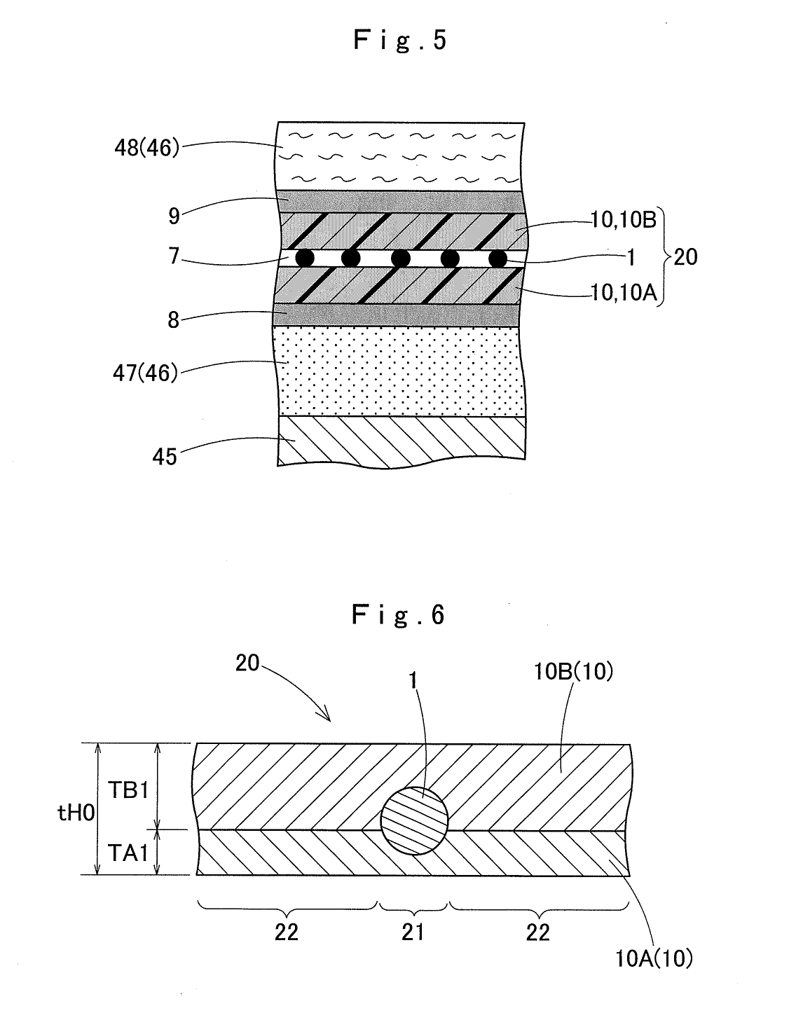

The heater manufacturing device 70 further includes above the hook mechanisms 72 a heat platen 77 which is reciprocably movable in an up and down direction. That is, the first substrate 10A is laid over the bottom platen 71 so the hook members 75 penetrate the substrate 10A, and the cord-shaped heater 1 is wound around the hook members 75 of the hook mechanisms 72 one after another, thus is arranged in a predetermined pattern on the substrate 10A. Then the second substrate 10B, which has a pressure-sensitive adhesive 7 (FIG. 5) on the surface facing toward the substrate 10A, is laid over there, and the heat platen 77 is moved downward such that heat and pressure are applied to the cord-shaped heater 1 and substrates 10A and 10B. With heat and pressure, the substrates 10A, 10B and the cord-shaped heater 1 are bonded and fixed together with the pressure-sensitive adhesive 7. The adhesive 7 used to bond the substrates 10A and 10B together is a pressure-sensitive adhesive of acrylic polymer or the like, in order not to hinder the retractility of the heater element 20. In this specific embodiment, the thickness of the adhesive 7 applied to the substrate 10B is 0.1 mm, and the weight of the adhesive 7 per unit area is 0.01 g/cm².

When the heat platen 77 is moved downward, the hook members 75 of the hook mechanisms 72 move downward against the biasing force of the coil springs 76. Thus the heater element 20 is formed into a flat plate having flexibility in which the cord-shaped heater 1 is fixed between the substrates 10A and 10B.

In other words, in the heater element 20 obtained as a result of hot pressing, the region where the cord-shaped heater 1 is disposed, namely, a heater-allocated region 21, and the region where the cord-shaped heater 1 is not disposed, i.e., an unallocated region 22, have the same thicknesses and form a flat plate, as shown in FIG. 6.

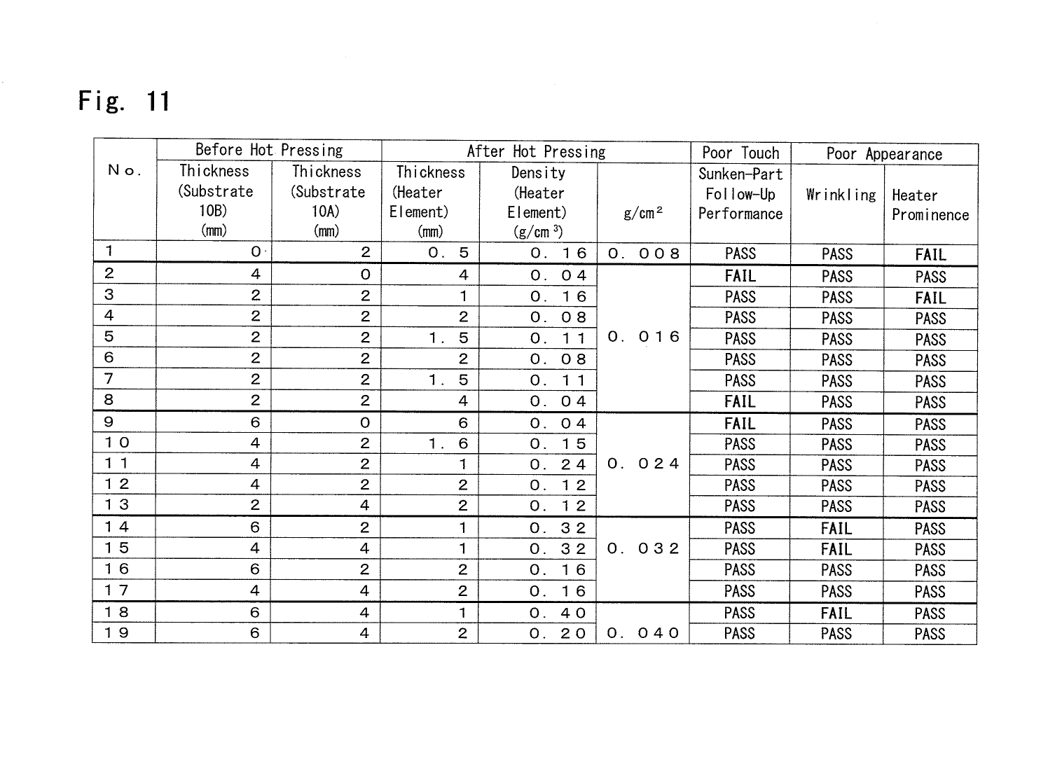

The thickness tH0 of the heater element 20 after hot pressing is 2.0 mm. As described above, the thickness TA1 of the substrate 10A after being subjected to hot pressing is 0.5 mm while the thickness TB1 of the substrate 10B after hot pressing is 1.5 mm. After hot pressing, the weight per unit volume at the unallocated region 22 except the weight of the adhesive 7 (i.e., the weight per unit volume of the substrates 10A and 10B only) is 0.12 g/cm³ and the weight per unit area at the unallocated region 22 except the weight of the adhesive 7 is 0.24 g/cm² (See No. 12 in the table of FIG. 11).

To explain numerical values in the table of FIG. 11, in the columns of “After Hot Pressing”, the “Thickness (mm)” represents numerical values of thicknesses at the unallocated region 22 including the adhesive 7, whereas the “Density (g/cm³)” and the “Weight per Unit Area (g/cm²)” represent numerical values of weights at the unallocated region 22 except the adhesive 7.

Since the two sheets of the substrates 10A and 10B are bonded together with the adhesive 7 with a weight per unit area of 0.01 g/cm², the weight per unit area (g/cm²) at the unallocated region 22 including the adhesive 7 will be such a value that 0.01 g/cm² is added to the value after hot pressing in the table of FIG. 11.

The opposite ends of the cord-shaped heater 1 of the heater element 20 manufactured by hot pressing are connected to the lead wires 31, and the temperature control device 32 is located at a predetermined position of the lead wires 31. Then if an extended region 10a of the substrates 10A and 10B, which has not been subjected to hot pressing, is wrapped around a vicinity of the temperature control device 32, the heater unit 30 is provided for mounting on the steering wheel 40.

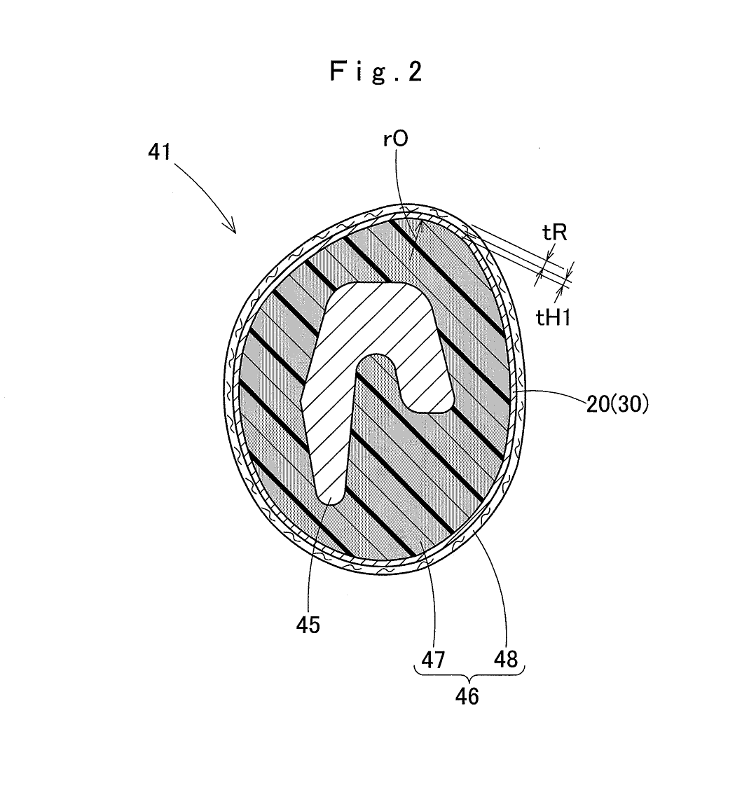

As shown in FIG. 1, the steering wheel 40 on which the heater unit 30 is mounted includes a rim section 41 for holding for steering, a boss 43 located at the center of the rim section 41 and a plurality of spokes 42 interconnecting the rim section 41 and the boss 43. The rim section 41 includes a rim core 45 formed from such metal as aluminum alloy and a cladding member 46 covering the rim core 45. The rim core 45 is located at a generally center of a sectional shape of the rim section 41 as shown in FIG. 2. The cladding member 46 includes a base cladding 47 disposed adjacent the rim core 45 and formed from such synthetic resin as urethane and a leather section 48 disposed on the outer surface and fabricated of natural leather, synthetic leather or the like. The heater unit 30 is disposed between the base cladding 47 and the leather section 48, and the lead wires 31 are wired through the spokes 42 and boss 43 and connected to a predetermined electric circuit of the vehicle for supplying electricity to the heater unit 30 when demanded. Thus the heater unit 30 raises the temperature of the mounting areas 41a located on the left and right regions on the rim section 41.

When the heater unit 30 is actually mounted on the steering wheel 40, the heater unit 30 is mounted on the steering wheel 40 before the leather section 48 is provided. That is, the heater unit 30 is attached to the base cladding 47 molded around the rim core 45, then the leather section 48 is wrapped around an outer circumference of the substrate 10B. At this time, a double-sided tape is attached to an outer surface of each of the substrates 10A and 10B, and a release sheet is removed from each of the tapes to adhere the substrate 10A to the base cladding 47, and to adhere the substrate 10B to the leather section 48, such that the heater element 20 is disposed on the outer surface of the base cladding 47 and the leather section 48 is arranged on the outer surface of the heater element 20, thus completing the leather-covered steering wheel 40.

As shown in FIG. 2, after the leather section 48 is provided, the thickness tR of the leather section 48 at the rim section 41 is 1.3 mm, and the thickness tH1 of the heater element 20 is 1.0 mm. The minimum radius of curvature on the outer surface of the base cladding 47 is about 2 mm.

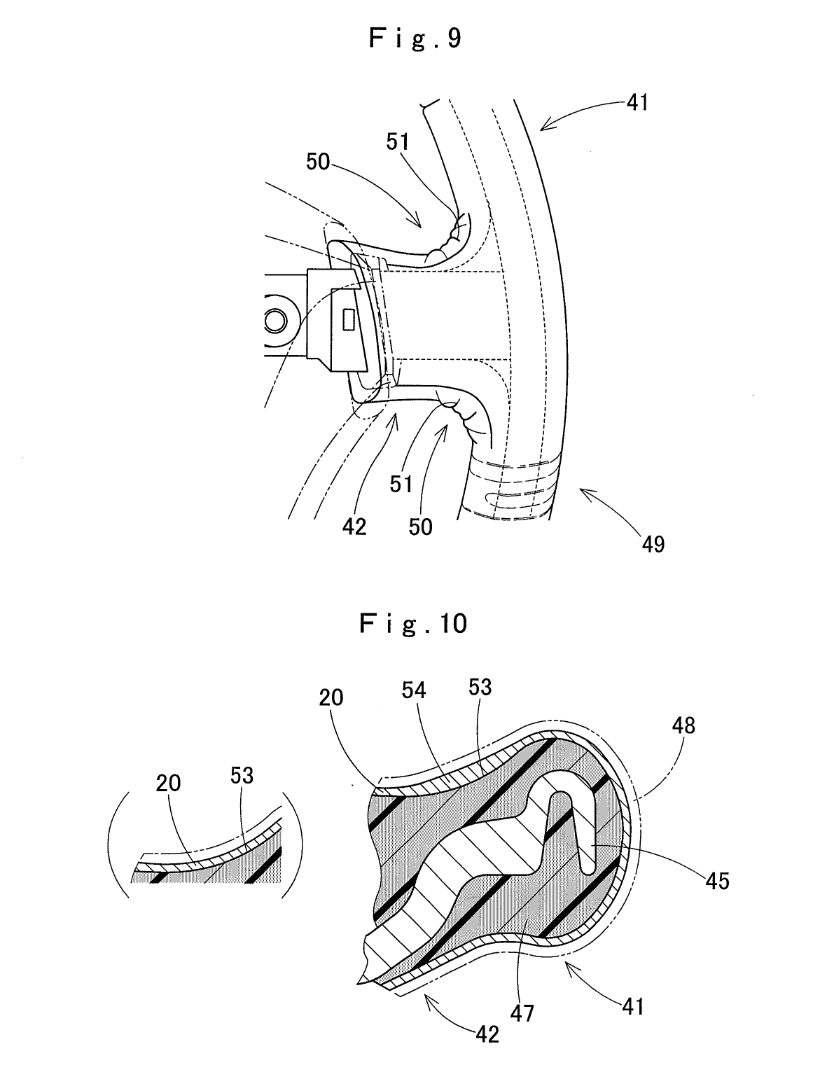

The steering wheel 40 manufactured as described above has no such protrusion, i.e., no such heater prominence 49, as shown in FIG. 9, caused by the presence of the cord-shaped heater 1 on the leather section 48, and further has no wrinkles 51 which would otherwise appear at the border between the rim section 41 and spoke 42 on an inner circumference of the rim section 41 as shown in FIG. 9. Moreover, the steering wheel 40 will have no such thick and flat region 54 as shown in FIG. 10, which would be caused by failure, of the heater element 20, to follow the sunken part 53 in shape when there is a sunken part 53 in a vicinity of the border between the rim section 41 and spoke 42 on the base cladding 47 (if the heater element 20 is capable of following the shape of the sunken part 53, the sunken part 53 will be finished as indicated in a parenthesis of FIG. 10). That is, the steering wheel 40 maintains a good appearance although equipped with a heater element 20 (heater unit 30).

That is, in a hot-pressed state with the cord-shaped heater 1 fixed between the substrates 10A and 10B, the heater element 20 of the foregoing embodiment has a thickness tH0 of 2.00 mm, which exceeds 1.00 mm, and the weight per unit area at the unallocated region 22 except the weight of the adhesive 7, i.e., the weight per unit area of only the substrates 10A and 10B, is 0.024 g/cm², which is within a range of 0.016 to 0.040 g/cm². This configuration provides an adequate cushioning property to the substrates 10A and 10B around the cord-shaped heater 1, and due to this cushioning property, a protrusive shape, i.e., a heater prominence, caused by the presence of the cord-shaped heater 1 is prevented from appearing on the outer surface of the leather section 48 although the heater element 20 is disposed at an inner side of the leather section 48 (i.e., around the base cladding 47) in a bent fashion at the rim section 41 of the steering wheel 40, provided that the wire diameter d0 of the cord-shaped heater 1 is normal. Here, the wire diameter d0 of the cord-shaped heater 1 is normally around 0.25 to 0.37 mm.

Therefore, the heater element 20 of the foregoing embodiment does not affect an appearance of a product on which the heater element 20 is mounted, such as a rim section 41 of a steering wheel 40, even if the heater element 20 is mounted thereon in a bent fashion.

In the heater element 20 of the foregoing embodiment, the cord-shaped heater 1 is fixed between the substrates 10A and 10B in a sandwiched fashion by hot pressing with the aid of an adhesive 7. This configuration facilitates the manufacturing of the heater element 20 since the fixing of the cord-shaped heater 1 to the substrates 10A and 10B are conducted easily with no need of sewing or the like. It will be understood that the heater element 20 (i.e., heater unit 30) will be heated when energized without affecting the appearance of an outer surface of the rim section 41 on which the heater element 20 is mounted.

A table in FIG. 11 shows a result of a test of the appearance and touch of leather-covered steering wheels which are manufactured in a like way as described above. In order to compose the steering wheels subjected to the test, a variety of combinations of the substrates 10B, which are adapted to be disposed adjacent the leather section 48, and the substrates 10A, which are adapted to be disposed adjacent the base cladding 47, with different thicknesses before being subjected to hot pressing were prepared. Then those substrates 10B and 10A were subjected to hot pressing with different compression rates so as to provide various heater elements with different thicknesses, densities (weights per unit volume) and weights per unit area.

Each of the substrates 10A and 10B used in the test is a sheet-shaped member formed from foamed polyurethane resin with an apparent density of 0.04 g/cm³ (JIS K 7222) and a hardness of 11.77 (JIS K6400-2), as described above.

Evaluations in the table of FIG. 11 are now explained. “Sunken Part Follow-Up Performance” means a capability of a heater element to follow the sunken part 53 in shape, if there is a sunken part 53 in a mounting area of the heater element as shown in FIG. 10, so as to make the sunken state of the sunken part 53 visible from outside. If the heater element has no or insufficient sunken-part follow-up capability, the sunken part 53 would be filled up by a thick region 54 and become flat, thereby degrading the appearance as well as the touch. In that case, a “FAIL” evaluation is given. A “PASS” evaluation in the Sunken Part Follow-Up Performance means that the heater element followed the shape of the sunken part 53 as depicted in a parenthesis in FIG. 10. “Wrinkling” represents a situation where wrinkles 51 appear on the leather section 48 as shown in FIG. 9, and if that occurred, a “FAIL” evaluation was given, since the heater element has degraded the appearance of the steering wheel. “Heater Prominence” represents a phenomenon in which protrusions due to the presence of the cord-shaped heater appear on an outer surface of the leather section 48. If that occurred, a “FAIL” evaluation was given since the heater element degraded the appearance of the steering wheel. Those heater elements which had no such phenomena got “PASS” evaluations.

In the test shown in FIG. 11, No. 1, No. 2 and No. 9, in which a cord-shaped heater 1 is not well fixed, i.e., arranged on only one substrate 10A or 10B, instead of a configuration where a cord-shaped heater 1 is fixed between a pair of the substrates 10A and 10B, are also listed as reference examples.

As seen from the table, practical weights per unit area of the substrates 10A and 10B only, except the weight of the adhesive 7, of No. 3 to 8 and No. 10 to 19 except No. 2 and 9 were within a range of 0.016 to 0.040 g/cm². However, No. 3, whose thickness tH0 of the heater element 20 after hot pressing does not exceed 1.00 mm, got a heater prominence (see reference numeral 49 in FIG. 9 indicating a heater prominence) and was evaluated as “FAIL”. As a result, the heater element of No. 3 is eliminated from the group of No. 3 to 8 and No. 10 to 19 at the “Heater Prominence” evaluation.

The thickness of the heater element 20 of the foregoing embodiment after being subjected to hot pressing is 2.00 mm, which is less than 4.00 mm.

The thickness tH0 no less than 4.00 mm after hot pressing is too thick and affects the flexibility of the heater element 20 and degrades the sunken-part follow-up capability. By way of example, although the practical weight per unit area of the substrates 10A and 10B only, except the weight of the adhesive 7, of No. 8 is within a range of 0.016 to 0.040 g/cm², with the thickness tH0 of 4.00 mm, No. 8 failed in the sunken-part follow-up performance, thus degrading the appearance of the steering wheel. As a result, at the “Sunken-Part Follow-Up Performance” evaluation, the heater element No. 8 is eliminated from the group of No. 4 to 8 and No. 10 to 19 which passed the “Heater Prominence” evaluation.

In the heater element 20 of the foregoing embodiment, the weight per unit volume of the substrates 10A and 10B only, except the weight of the adhesive 7, after hot pressing is 0.24 g/cm³, which is less than 0.32 g/cm³.

If the weight per unit volume of only the substrates 10A and 10B after hot pressing is no less than 0.32 g/cm³, a heater element loses elasticity and easily wrinkles. Heater elements No. 14, 15 and 18 with the weight per unit volume of only the substrates 10A and 10B of 0.32 g/cm³ or 0.40 g/cm³ got wrinkles and were evaluated as “FAIL” at the “Wrinkling” evaluation. That is, the heater elements No. 14, 15 and 18 are eliminated from the group of No. 4 to 7 and 10 to 19 which passed the “Heater Prominence” and “Sunken-Part Follow-Up Performance” evaluations.

As a consequence, the test revealed that the heater elements No. 4 to 7, 10 to 13, 16, 17 and 19 will be adequate to be mounted on a mounting area 41a of a rim section 41 in a bent fashion, based on the evaluations of “Heater Prominence”, the “Sunken-Part Follow-Up Performance” and “Wrinkling”.

The thickness tH0 of the heater element 20 of the foregoing embodiment after hot pressing is 2.00 mm. This thickness not only prevents a heater prominence from occurring but also exerts an adequate sunken-part follow-up performance and a sufficient elasticity for avoiding wrinkles. Therefore, the heater element 20 will be adequate for providing a leather-covered steering wheel 40 with a good appearance as well as a good touch.

In the foregoing embodiment, out of the two substrates 10A and 10B, the substrate 10B for mounting adjacent the leather section 48 has a greater thickness TB 1 (1.5 mm) than the substrate 10A for mounting adjacent the base cladding 47. The thickness TA1 of the substrate 10A is 0.5 mm.

This configuration that the substrate 10B for mounting adjacent the leather section 48 is greater in proportion of the thickness than the substrate 10A will increase the cushioning property at a side of the leather section 48 when mounted on a rim section 41 and help prevent a prominence on a surface of the leather section 48 caused by the cord-shaped heater 1 from being recognized not only in vision but also in touch. This configuration will thus provide an evenly good touch everywhere if the thickness of the substrate 10B varies in places at the heater-allocated region 21 where the cord-shaped heater 1 is disposed.

Out of the heater elements which passed in all the evaluations in FIG. 11, the heater elements No. 10, 11, 16 and 19 have greater thicknesses at a side of the leather section 48, except No. 12 of the foregoing embodiment. These heater elements exhibited good touch in a steady fashion as well as No. 12, when mounted on the mounting areas 41a of the steering wheel.

The heater element 20 has been described in the foregoing embodiment as is adapted to be mounted on a steering wheel 40 for a vehicle. The steering wheel includes a rim section 41 for holding for steering, the rim section 41 including a rim core 45 and a cladding member 46 that covers the ring core 45. The cladding member 46 includes a base cladding 47 disposed adjacent the rim core 45 and a leather section 48 disposed on an outer surface of the steering wheel 40. The heater element 20 is disposed between the base cladding 47 and the leather section 48. This configuration provides a good-looking steering wheel 40 which has no heater prominence due to the presence of the cord-shaped heater 1.

However, the use of the heater element of the invention should not be limited to mounting on a mounting area 41 a of a rim section 41 of a steering wheel 40. The heater element of the invention may be mounted on an outer surface of such straight or curved bar- or stick-shaped products as a handrail, a hand grip for a motorcycle and a walking stick, provided that the heater element is mounted on the product in a bent fashion for heating the product.

What is claimed is:

1. A heater element having a sheet shape with flexibility, comprising:
a pair of substrates formed from foamed polyurethane resin; and
a cord-shaped heater arranged in a predetermined pattern between the substrates, the substrates being bonded together by hot pressing with an adhesive disposed between the substrates such that the cord-shaped heater is fixed between the substrates,
wherein a thickness of the heater element after being subjected to hot pressing exceeds 1.00 mm and a weight per unit area of the heater element after being subjected to hot pressing except a weight of the adhesive at an unallocated region where the cord-shaped heater is not disposed is within a range of 0.016 to 0.040 g/cm².

2. The heater element as set forth in claim 1 wherein the thickness of the heater element is less than 4.00 mm.

3. The heater element as set forth in claim 1 wherein a weight per unit volume of the heater element after being subjected to hot pressing at the unallocated region except the weight of the adhesive is less than 0.32 g/cm³.

4. The heater element as set forth in claim 3 wherein the thickness of the heater element is less than 4.00 mm.

5. The heater element as set forth in claim 1 wherein:
the thickness of the heater element is 2.00 mm; and
a weight per unit volume of the heater element after being subjected to hot pressing at the unallocated region except the weight of the adhesive is less than 0.32 g/cm³.

6. A heater element adapted to be mounted on a steering wheel comprising a rim section for holding for steering, the rim section comprising a rim core and a cladding member covering the ring core, the cladding member comprising a base cladding disposed adjacent the rim core and a leather section disposed on an outer surface of the steering wheel, the heater element having a sheet shape with flexibility for mounting between the base cladding and the leather section of the steering wheel and comprising:
a pair of substrates formed from foamed polyurethane resin; and
a cord-shaped heater arranged in a predetermined pattern between the substrates, the substrates being bonded together by hot pressing with an adhesive disposed between the substrates such that the cord-shaped heater is fixed between the substrates,
wherein a thickness of the heater element after being subjected to hot pressing exceeds 1.00 mm and a weight per unit area of the heater element after being subjected to hot pressing except a weight of the adhesive at an unallocated region where the cord-shaped heater is not disposed is within a range of 0.016 to 0.040 g/cm².

7. The heater element as set forth in claim 6 wherein the thickness of the heater element is less than 4.00 mm.

8. The heater element as set forth in claim 7 wherein, out of the two substrates, the substrate for mounting adjacent the leather section has a greater thickness than the substrate for mounting adjacent the base cladding.

9. The heater element as set forth in claim 6 wherein a weight per unit volume of the heater element after being subjected to hot pressing at the unallocated region except the weight of the adhesive is less than 0.32 g/cm³.

10. The heater element as set forth in claim 9 wherein, out of the two substrates, the substrate for mounting adjacent the leather section has a greater thickness than the substrate for mounting adjacent the base cladding.

11. The heater element as set forth in claim 6 wherein:
the thickness of the heater element is 2.00 mm; and
a weight per unit volume of the heater element after being subjected to hot pressing at the unallocated region except the weight of the adhesive is less than 0.32 g/cm³.

12. The heater element as set forth in claim 11 wherein, out of the two substrates, the substrate for mounting adjacent the leather section has a greater thickness than the substrate for mounting adjacent the base cladding.

13. The heater element as set forth in claim 6 wherein, out of the two substrates, the substrate for mounting adjacent the leather section has a greater thickness than the substrate for mounting adjacent the base cladding.

14. A steering wheel comprising:
a rim section for holding for steering, the rim section comprising a rim core and a cladding member that covers the ring core, the cladding member comprising a base cladding disposed adjacent the rim core and a leather section disposed on an outer surface of the steering wheel; and
a heater element disposed between the base cladding and the leather section, the heater element having a sheet shape with flexibility and comprising a pair of substrates formed from foamed polyurethane resin and a cord-shaped heater arranged in a predetermined pattern between the substrates, the substrates being bonded together by hot pressing with an adhesive disposed between the substrates such that the cord-shaped heater is fixed between the substrates, wherein a thickness of the heater element after being subjected to hot pressing exceeds 1.00 mm and a weight per unit area of the heater element after being subjected to hot pressing except a weight of the adhesive at an unallocated region where the cord-shaped heater is not disposed is within a range of 0.016 to 0.040 g/cm².

15. The steering wheel as set forth in claim 14 wherein the thickness of the heater element is less than 4.00 mm.

16. The steering wheel as set forth in claim 14 wherein a weight per unit volume at the unallocated region of the heater element after being subjected to hot pressing except the weight of the adhesive is less than 0.32 g/cm³.

17. The steering wheel as set forth in claim 14 wherein:
the thickness of the heater element is 2.00 mm; and
a weight per unit volume at the unallocated region of the heater element after being subjected to hot pressing except the weight of the adhesive is less than 0.32 g/cm³.

18. The steering wheel as set forth in claim 17 wherein, out of the two substrates of the heater element, the substrate disposed adjacent the leather section has a greater thickness than the substrate disposed adjacent the base cladding.

19. The steering wheel as set forth in claim 14 wherein, out of the two substrates of the heater element, the substrate disposed adjacent the leather section has a greater thickness than the substrate disposed adjacent the base cladding.
